(19) United States
(12) Patent Application Publication
(10) Pub. No.: US 2006/0005351 A1
(43) Pub. Date: Jan. 12, 2006

(54) Omni-directional rolling support device

(76) Inventor: Chong H. Choo, Walnut (KR)

Correspondence Address: MACPHERSON KWOK CHEN & HEID LLP, 1762 TECHNOLOGY DRIVE, SUITE 226, SAN JOSE, CA, 95110, US

(21) Appl. No.: 10/889,557

(22) Filed: Jul. 12, 2004

(51) Int. Cl. B60B 33/08

(52) U.S. Cl. 16/24

(57) ABSTRACT

An omni-directional rolling support device includes a ball member; a cup member, a shaft having a first end and a second end, and a hollow supporting unit. The ball member is disposed in contact between the cup member inner surface and a planar surface. The ball member is in sliding contact with a cup member inner surface and non-sliding contact with the planar surface. The shaft first end is attached to the cup member and the cup member is rotationally fixed relative to the elongated member. The shaft second end can be attached to a supported object to provide rolling support across the planar surface in any direction. A hollow support unit attached to the shaft and surrounding the cup member can selectively advance and retreat along a central axis. The hollow support unit can extend to contact the planar surface and inhibit rolling across the planar surface.

### FIELD OF THE INVENTION

The present invention relates to a rolling support device and especially to a vertically oriented omni-directional rolling support device capable of highly accurate placement.

### DESCRIPTION OF RELATED ART

The typical rolling support for furniture has traditionally been an offset caster. The presence of offset casters can make it difficult to accurately place an article of furniture since the caster can change orientation during movement causing the center of balance to shift. When a heavy item is placed on such a caster, it is difficult to change directions, especially in tight spaces, and often it is not possible to accurately place the furniture precisely in a desired location.

An individual moving such a piece of furniture supported by traditional casters will often encounter the problem where placement control is not accurate. The individual attempts to move the furniture a small distance in one direction only to find that the caster has changed position, and the furniture has shifted undesirably. Thus, the industry still requires an accurately placed, omni-directional rolling support for furniture or other articles without undue movement caused by caster reorientation.

### BRIEF SUMMARY OF THE INVENTION

The present invention, as defined in the claims, overcomes these disadvantages by describing an omni-directional rolling support that is aligned along a vertical axis, so that the furniture item may be easily moved over the horizontal surface, and accurately placed, without incurring a shift due to the reorientation of an offset caster. Further, once the furniture item is positioned, a hollow support unit can be used to contact the surface around the rolling support to lock the furniture item in place.

According to a preferred embodiment, a cup is attached to a first end of a shaft. The cup receives a ball that is in sliding contact with the cup inner surface. The ball is in non-sliding contact with a planar surface so a supported object, such as a furniture leg, attached to the second end of the shaft. Thus, the supported object is supported against the planar surface to roll on the ball across the planar surface in any direction. The shaft can be threaded for mating with a nut or other threaded member. The position of the furniture leg relative to the cup member may be adjusted by positioning the nut on the threaded shaft.

A hollow support unit has an open end and a closed end, the close end can be attached to the shaft and the open end is surrounding the cup. The hollow support unit can extend and retract along a central axis so that when the hollow support unit is extended, it contacts the planar surface and inhibits rolling movement along the planar surface. The hollow support unit is preferably cylindrical in shape.

### BRIEF DESCRIPTION OF THE DRAWINGS

The exact nature of this invention, as well as the objects and advantages thereof, will become readily apparent upon consideration of the following specification in conjunction with the accompanying drawings in which like reference numerals designate like parts throughout the figures thereof and wherein:

FIG. 1 shows a side-view of the omni-directional rolling support unit according to an embodiment of the present invention.

FIG. 2 shows a side-view of the omni-directional rolling support unit as it is positioned in a furniture leg according to an embodiment of the present invention.

FIG. 3 shows a side-view of the omni-directional rolling support device as it is mounted on a horizontal member with the supported member in a position closer to the cup member according to an embodiment of the present invention.

FIG. 4 shows a side-view of the omni-directional rolling support device as it is mounted on a horizontal member with the supported member in a position farther away from the cup member according to an embodiment of the present invention.

FIG. 5 shows a side-view of the support member in a retracted position according to an embodiment of the present invention.

FIG. 6 shows a side-view of the support member in a second position touching the horizontal surface and inhibiting movement according to an embodiment of the present invention.

FIG. 7 shows a side-view of the support member in a third position touching the horizontal surface and inhibiting movement according to an embodiment of the present invention.

FIG. 8 shows a bottom-up end-view of the support member according to an embodiment of the present invention.

FIG. 9 shows an exploded view showing the cylindrical extension components of the hollow support unit according to an embodiment of the present invention.

FIG. 10 shows a top plan view of the hollow support unit showing the through hole for mounting the hollow support unit to the shaft according to an embodiment of the present invention.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the intention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

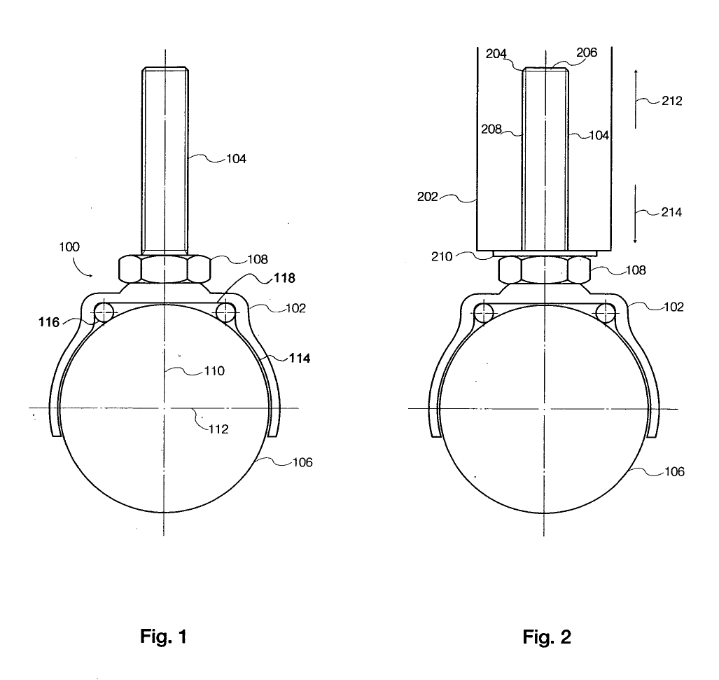

In reference to FIG. 1, a vertically oriented rolling support device 100 includes a cup 102 having an open end and a closed end. The cup 102 closed end is attached to one end of a shaft 104. The other end of the shaft 104 extends away from the cup 102 on an axis aligned with a central axis 110 of the cup 102. The shaft 104 can be considered an elongated member having a first end and a second end. Alternatively, the shaft 104 may be oriented at an oblique angle to the central axis of the cup so long as the central axis of the cup 102 is normal to the surface upon which the ball rests. In yet another alternative, the rolling support device 100 may be oriented horizontally to provide rolling support to a supported object such as a tray for carrying conveyed items against a vertical surface where the tray may by conveyed along a horizontal direction and then change to a vertical direction such as by an escalator along an assembly line.

The cup 102 receives a ball 106, and the ball 106 is retained in the cup 102. The ends of the cup 102 extend around the received ball 106 beyond the horizontal midline 112 of the ball so that the ball 106 is retained in the cup 102 after insertion. The cup 102 may be composed of metal or hard plastic while the ball 106 may be composed of plastic, TEFLON (R), or metal. The ball 106 is positioned in the cup 102 between the cup 102 and a planar surface such as a floor. The ball 106 is in sliding contact with the cup 102 inner surface 114 while the ball is in non-sliding contact with the planar surface.

The coefficient of static friction between the ball 106 and the planar surface is higher than the coefficient of static friction between the ball 106 and the cup 102 inner surface 114. Therefore, even from a rest position, the ball 106 is in sliding contact with the cup 102 inner surface 114, and in non-sliding contact with the planar surface to provide omni-directional rolling support for a supported object attached to the shaft 104 across the planar surface. The cup 102 is rotationally fixed relative to the shaft 104 so that when changing the direction of movement across the planar surface, the shaft 104 and cup 102 do not rotate. This allows accurate placement of an article of furniture, for example, and eliminates undue movement caused by off-set caster reorientation.

In one embodiment, a plurality of small-diameter spheres 116 are positioned between the ball 106 and the cup 102 inner surface 114, and occupy the corners of a shoulder-like circular cavity 118 positioned radially in proximity to the closed end of the cup 102, as shown in FIG. 1. The ball 106 rolls against the spheres 116 in the cavity 118. The spheres 116 can roll against the inner surface 114 or remain stationary while the ball 106 rolls against the surface of the spheres 116. The contact between the spherical surface of the ball 106 and the spherical surface of each sphere 116 allows for contact between the ball 106 and sphere 116 at a point, thereby reducing the friction between the ball 106 and the cup member 102 inner surface 114. The number of small-diameter spheres 116 is at least three and as many as will fit loosely within the circular cavity 118.

In one embodiment, the shaft 104 is treaded for mating with a complimentarily threaded member such as a nut 108 or other threaded member for engaging with the threaded shaft 104, for example. If a nut 108 is mounted on the shaft 104, the position of the nut on the shaft 104 determines the position of a supported object relative to the cup 102, and essentially determines the height of the supported object relative to a horizontal surface when the omni-directional rolling support device is oriented vertically over the horizontal surface.

In reference to FIG. 2, the rolling support device 100 supports a portion of an article of furniture such as a furniture leg 202 where a portion of the shaft 104 is inserted into a cavity 204 within the furniture leg 202. The shaft 104 may be surrounded by a spacing material 208 such as a plastic cylinder to flexibly engage with the shaft 104 within the cavity 204. The cavity 204 may include a pocket of empty space 206 above the location of the shaft 104 so that when the nut 108 is rotated about the shaft 104 in a first direction, the nut advances towards the cup 102, and the shaft 104 moves in a direction 212 farther into the cavity 204.

Alternatively, when the nut 108 is rotated about the shaft 104 in a second direction, the nut 108 retreats away from the cup 102 and the shaft 104 moves in a direction 214 out of the cavity 104. Thus, a nut 108 mounted on the threaded shaft 104 may be used in adjusting the height of the supported portion of a furniture leg 202, for example. The nut 108 has a first side and a second side, the first side of the nut 108 is oriented towards the cup 102 (proximal) while the second side of the nut 108 is oriented away from the cup 102 (distal) and toward the furniture leg 202.

A washer 210 may optionally be located between the nut 108 second side and the furniture leg 202. The nut 108 can be adjusted to both adjust the height of the furniture as well as to level an article of furniture having more than one leg. Alternatively, the shaft 104 may be smooth, not threaded, and can maintain an adjustable height for the furniture leg 202 based the addition of a properly sized spacer, or a plurality of spacers such as the washer 210 inserted on the shaft and between the cup 102 and the furniture leg 202.

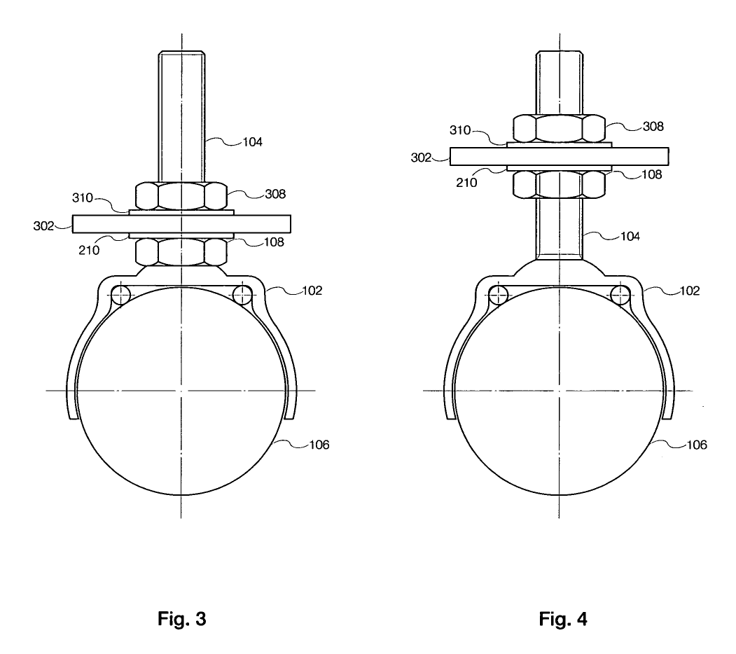

In reference to FIG. 3, a planar portion 302 of a supported object may be securely held between a first nut 108 and a second nut 308 on the threaded shaft 104. The planar portion 302 may be an extension of an article of furniture or may be planar portion within an article of furniture such as the bottom surface or shelf of an enclosure or cabinet. Alternatively, a first washer 210 may be placed against the second side of the first nut 108 as described previously. The upper surface of the first washer 210 is then placed adjacent to a lower surface of the planar portion 302.

An optional second washer 310 is placed over the threaded shaft 104 and adjacent to the top surface of the planar portion 302 and the second nut 308 is tightened on the threaded shaft 104. The first nut 108 and the second nut 308 are counter rotated against each other so the first nut 108 and the second nut 308 advance towards each other in order to securely hold the planar portion 302 of the supported object between them. The planar portion 302 can also be within a furniture leg 202 so that the omni-directional rolling support device 100 is held securely within the furniture leg 202. It is understood that the furniture leg 202 must also include an opening for inserting the second nut 308 as well as an optional washer 310 and to allow tightening of the second nut 308.

In reference to FIG. 4, the planar portion 302 is securely held at a distance away from the cup 102 compared to the view of FIG. 3. The position of the planar portion 302 may be adjusted to change the height of the planar portion 302 above a horizontal planar surface and to level the article of furniture as discussed.

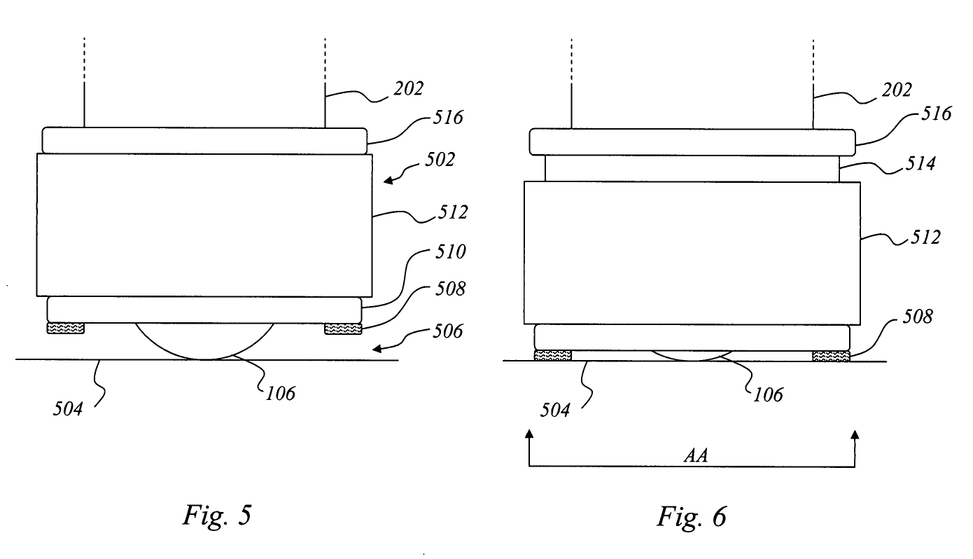

In reference to FIGS. 5-6, a hollow support unit 502 surrounds the ball 106, cup 102 and is attached to the shaft 104. The hollow support unit 502 can expand and retract (advance or retreat) along a central axis in order to contact the planar surface 504. When the hollow support unit 502 is retracted, a gap 506 exists between the planar surface 504 and the hollow support unit 502. When the hollow support unit 502 is expanded to contact the planar surface 504, the gap 506 is eliminated, and the hollow support unit 502 inhibits rolling of the omni-directional rolling support device 100 while providing a wider base of support for the supported object 202.

A frictional member 508 may be attached on the underside of the hollow support unit 502 on a contact ring 510 in order to provide added friction between the planar surface 504 and the contact ring 510 hollow support unit 502. The frictional member 508 may include a butyl rubber material, for example. The hollow support unit 502 in the presently preferred embodiment includes an outer cylinder 512, a threaded contact ring 510, and a threaded top cap 516.

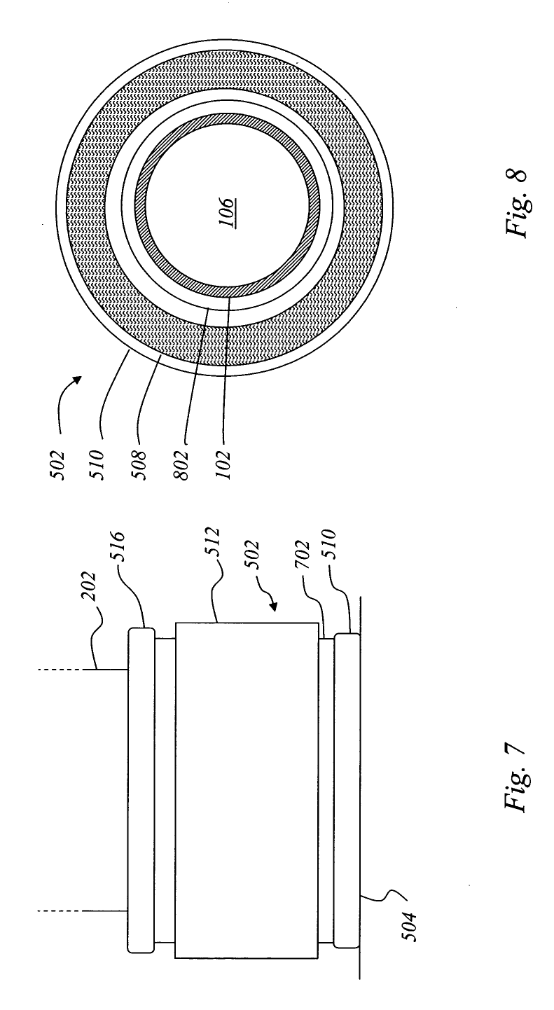

The outer cylinder 512 has a threaded inner portion (not shown) that mates with the threaded portions on the contact ring 510 and the threaded top cap 516 that the hollow support unit 502 can expand or contract along the central axis when the outer cylinder 512, contact ring 510, and the top cap 516 are rotated relative to each other. Either or both of the contact ring 510 and the top cap 516 may be extended relative to the outer cylinder 512. FIG. 5 shows both the contact ring 510 and the top cap 516 in a retracted position. FIG. 6 shows only the top cap 516 extended. FIG. 7 shows both the contact ring 510 and the top cap 516 extended in an embodiment that does not include the frictional member 508. The threaded portion 702 of the contact ring 510 is partially shown.

The hollow support unit 502 preferably includes an alloy DURALUMIN, but may be composed of aluminum alloy or another suitable, high tensile-strength material. Duralumin is a particular alloy of aluminum (over 90%) with copper (about 4%), magnesium (0.5%-1%), and manganese (less than 1%). Before a final heat treatment the duralumin alloy is ductile and malleable, but after the heat treatment a reaction between the aluminum and magnesium produces an increased hardness and tensile strength. Because it is light weight and durable, duralumin is widely used in the aircraft industry.

FIG. 8 is an end-view of the omni-directional rolling support device 100 in the direction AA as shown in FIG. 6. The contact ring 510 has an inner edge 802. In another embodiment, the hollow support unit 502 is non-cylindrical and includes an outer shell 512 and an inner shell 514 which advance or retreat along a central axis by pushing and pulling the overlapping shells through a series of detents comprising facing projections to positively position the inner and outer shells relative to each other at various positions.

In one alternative embodiment, the cross-sectional view as in FIG. 8 of the non-cylindrical hollow support unit 502 is triangular in shape. In another alternative embodiment, the cross-sectional view as in FIG. 8 of the non-cylindrical hollow support unit 502 is square in shape. Finally, in another alternative embodiment, the cross-sectional view as in FIG. 8 of the non-cylindrical hollow support unit 502 is hexagonal in shape.

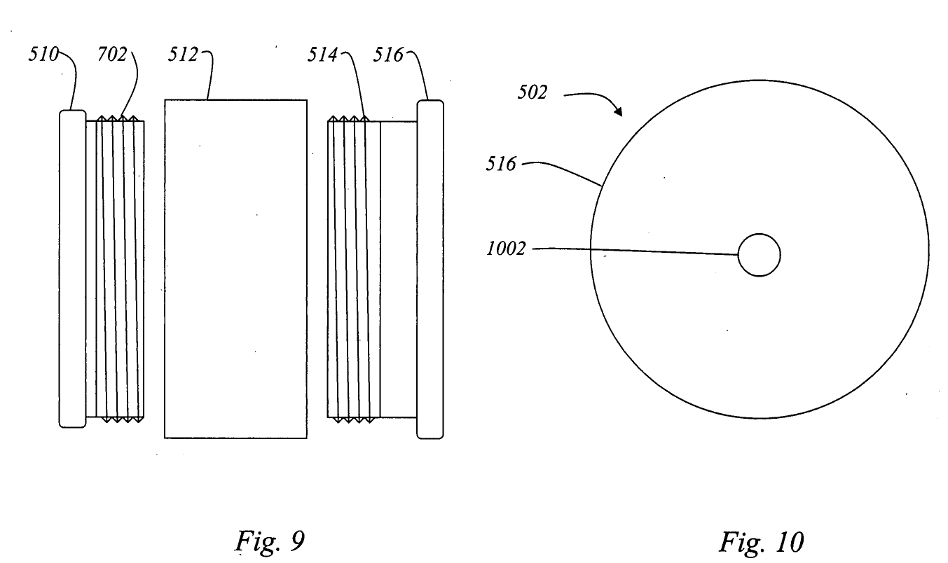

FIG. 9 shows an exploded view showing the cylindrical extension components (510, 516) separated from the outer cylinder 512 of the hollow support unit 502. FIG. 10 shows a top view of the hollow support unit showing the through hole for mounting the top cap 516 of the hollow support unit 502 to the shaft 104. The through hole 1002 may be threaded to mate with a threaded shaft 104.

Those skilled in the art will appreciate that various adaptations and modifications of the just-described preferred embodiments can be configured without departing from the scope and spirit of the invention. Therefore, it is to be understood that, within the scope of the amended claims, the invention may be practiced other than as specifically described herein.

What is claimed is:

1. An omni-directional rolling support device, comprising:
a cup member having an inner surface for receiving a ball member, the ball member for being disposed in contact between the cup member inner surface and a planar surface, the ball member for being in sliding contact with the cup member inner surface and for being in non-sliding contact with the planar surface; and
an elongated member having a first end and a second end, the elongated member first end being attached to the cup member, the cup member being rotationally fixed relative to the elongated member, the elongated member second end for attachment to a supported object, the supported object for being supported against the planar surface to roll on the ball member across the planar surface in any direction.

2. The omni-directional rolling support device of claim 1,
wherein the elongated member is oriented substantially vertically and the planar surface is oriented substantially horizontally.

3. The omni-directional rolling support device of claim 1,
wherein the cup member has a central axis, and
wherein the elongated member has a central axis, the elongated member central axis being oriented along a line extending from the central axis of the cup member.

4. The omni-directional rolling support device of claim 3,
wherein the shaft of the elongated member is threaded for threadably mating with a complimentarily threaded member.

5. The omni-directional rolling support device of claim 4, further comprising:
a first nut member disposed around the threaded elongated member, the first nut member having complimentary threads for threadably mating with the threaded elongated member,
wherein when the first nut member is rotated in a first direction about the axis of the threaded elongated member the first nut member advances towards the cup member, and
wherein when the first nut member is rotated in a second direction opposite to the first direction about the axis of the threaded elongated member the first nut member retreats away from the cup member.

6. The omni-directional rolling support device of claim 5,
wherein the first nut member has a first side and a second side, the first side of the first nut member being disposed proximal to the cup member in a plane substantially normal to the central axis of the threaded elongated member, the second side of the first nut member being disposed distal to the cup member in a plane substantially parallel to the first side of the first nut member, the second side of the first nut member being in contact with the supported object, the position of the first nut member on the elongated member determining the distance between the supported object and the cup member.

7. The omni-directional rolling support device of claim 6,
a second nut member disposed around the threaded elongated member, the second nut member having complimentary threads for threadably mating with the threaded elongated member,
wherein when the second nut member is rotated in a first direction about the axis of the threaded elongated member the second nut member advances towards the cup member, and
wherein when the second nut member is rotated in a second direction opposite to the first direction about the axis of the threaded elongated member the second nut member retreats away from the cup member, the first nut member and the second nut member being counter rotated against each other to secure a portion of the supported object between the second side of the first nut member and a first side of the second nut member.

8. The omni-directional rolling support device of claim 2,
wherein the supported object is an article of furniture.

9. An omni-directional rolling support device, comprising:
a ball member;
a cup member having an inner surface for receiving the ball member, the ball member being disposed in contact between the cup member inner surface and a planar surface, the ball member being in sliding contact with the cup member inner surface and for being in non-sliding contact with the planar surface; and
an elongated member having a first end and a second end, the elongated member first end being attached to the cup member, the cup member being rotationally fixed relative to the elongated member, the elongated member second end for attachment to a supported object, the supported object for being supported against the planar surface to roll on the ball member across the planar surface in any direction.

10. The omni-directional rolling support device of claim 9,
wherein the elongated member is oriented substantially vertically and the planar surface is oriented substantially horizontally, and
wherein the supported object is an article of furniture.

11. An omni-directional rolling support device, comprising:
a ball member;
a cup member having a closed end and an open end, the cup member having an inner surface for receiving the ball member through the open end, the ball member for being disposed in contact between the cup member inner surface and a planar surface, the cup member having a circular cavity disposed radially in the cup member in proximity to the cup member closed end and having a plurality of spheres disposed between the ball member and the cup member closed end for providing support between the ball member and the cup member, the ball member being in rolling contact with the plurality of spheres in the cup member circular cavity, the ball member for being in non-sliding contact with the planar surface;
an elongated member having a first end and a second end, the elongated member first end being attached to the cup member, the cup member being rotationally fixed relative to the elongated member, the elongated member second end for attachment to a supported object, the supported object for being supported against the planar surface to roll on the ball member across the planar surface in any direction; and
a hollow support unit attached to the elongated member and disposed surrounding the cup member, the hollow support unit being enabled to selectively advance and retreat along a central axis, the hollow support unit being enabled to contact the planar surface when extended, the hollow support unit for inhibiting rolling when extended to contact the planar surface.

12. The omni-directional rolling support device of claim 11, further comprising:
a frictional member;
wherein the hollow support unit is substantially in the form of a cylinder having a first end and a second end, the first end being closed and the second end being open to surround the cup member, the first end of the hollow support unit being attached to the elongated member, the second end of the hollow support unit for receiving the frictional member being disposed between the hollow support unit and the planar surface, the hollow support unit being extended along the axis of the cylinder to enable the frictional member to contact the planar surface to inhibit rolling across the planar surface.

13. The omni-directional rolling support device of claim 12, the hollow support unit further comprising:
an inner cylinder having a threaded outer surface portion; and
an outer cylinder having a threaded inner surface portion for threadably mating with the inner cylinder threaded outer surface portion, the inner cylinder being closed at one end and being attached to the elongated member,
wherein the hollow support unit is expanded by rotating the outer cylinder about the inner cylinder so the outer cylinder advances in a direction from the elongated member to the cup member.

14. The omni-directional rolling support device of claim 13,
wherein the elongated member is oriented substantially vertically and the planar surface is oriented substantially horizontally, and
wherein the supported object is an article of furniture.

15. An omni-directional rolling support device, comprising:
a ball member;
a cup member having an inner surface for receiving the ball member, the ball member being disposed in contact between the cup member inner surface and a planar surface, the ball member being in sliding contact with the cup member inner surface and for being in non-sliding contact with the planar surface;
an elongated member having a first end and a second end, the elongated member first end being attached to the cup member, the cup member being rotationally fixed relative to the elongated member, the elongated member second end for attachment to a supported object, the supported object for being supported against the planar surface to roll on the ball member across the planar surface in any direction; and
a hollow support unit attached to the elongated member and disposed surrounding the cup member, the hollow support unit being enabled to selectively advance and retreat along a central axis, the hollow support unit being enabled to contact the planar surface when extended, the hollow support unit for inhibiting rolling when extended to contact the planar surface.

16. The omni-directional rolling support device of claim 15,
wherein the cup member has a central axis, and
wherein the elongated member has a central axis, the elongated member central axis being oriented along a line extending from the central axis of the cup member, the cup member, elongated member, and hollow support unit being oriented along the same central axis.

17. The omni-directional rolling support device of claim 16,
wherein the shaft of the elongated member is threaded for threadably mating with a complimentarily threaded member.

18. The omni-directional rolling support device of claim 17, further comprising:
a first nut member disposed around the threaded elongated member, the first nut member having complimentary threads for threadably mating with the threaded elongated member,
wherein when the first nut member is rotated in a first direction about the axis of the threaded elongated member the first nut member advances towards the cup member, and
wherein when the first nut member is rotated in a second direction opposite to the first direction about the axis of the threaded elongated member the first nut member retreats away from the cup member.

19. The omni-directional rolling support device of claim 18,
wherein the first nut member has a first side and a second side, the first side of the first nut member being disposed proximal to the cup member in a plane substantially normal to the central axis of the threaded elongated member, the second side of the first nut member being disposed distal to the cup member in a plane substantially parallel to the first side of the first nut member, the second side of the first nut member being in contact with the supported object, the position of the first nut member on the elongated member determining the distance between the supported object and the cup member.

20. The omni-directional rolling support device of claim 19,
a second nut member disposed around the threaded elongated member, the second nut member having complimentary threads for threadably mating with the threaded elongated member,
wherein when the second nut member is rotated in a first direction about the axis of the threaded elongated member the second nut member advances towards the cup member, and
wherein when the second nut member is rotated in a second direction opposite to the first direction about the axis of the threaded elongated member the second nut member retreats away from the cup member, the first nut member and the second nut member being counter rotated against each other to secure a portion of the supported object between the second side of the first nut member and a first side of the second nut member.

21. The omni-directional rolling support device of claim 20,
wherein the elongated member is oriented substantially vertically and the planar surface is oriented substantially horizontally, and
wherein the supported object is an article of furniture.
